(19) United States
(12) Patent Application Publication
(10) Pub. No.: US 2018/0272834 A1
(43) Pub. Date: Sep. 27, 2018

(54) COOLING APPARATUS AND METHOD FOR COOLING A BATTERY IN A VEHICLE BY MEANS OF A COOLANT AND VEHICLE HAVING SUCH A COOLING APPARATUS

(71) Applicant: FORD GLOBAL TECHNOLOGIES, LLC, Dearborn, MI (US)

(72) Inventor: Marcus Hahn, Bergisch (DE)

(21) Appl. No.: 15/926,717

(22) Filed: Mar. 20, 2018

(30) Foreign Application Priority Data
Mar. 27, 2017 (DE) 102017205081.0

(51) Int. Cl. B60H 1/00; H01M 10/625; H01M 10/613; B60L 11/18; H01M 10/663; B60H 1/32

(52) U.S. Cl. CPC B60H 1/00278; H01M 10/625; H01M 10/613; B60H 1/00385; H01M 10/663; B60H 1/3233; B60H 2001/00307; B60L 11/1874

(57) ABSTRACT

A cooling apparatus for cooling a battery in a vehicle by means of a coolant includes a first coolant circuit including a first heat exchanger for heat transfer between the coolant and the battery, a pumping device, and a collecting vessel for the coolant connected to one another by means of coolant lines. A condensate line connects the collecting vessel to an air conditioning system of the vehicle for the introduction of condensate. A related method for cooling a battery is also disclosed.

### TECHNICAL FIELD

This document relates to a cooling apparatus and a method for cooling a battery in a vehicle by means of a coolant. In addition, a vehicle having such a cooling apparatus is defined.

### BACKGROUND

In vehicles, accumulators, hereinafter referred to as batteries, are used as rechargeable stores for electrical energy. Besides the use as a starter battery, electric and hybrid electric vehicles possess traction batteries for the electrical propulsion of the vehicle.

For instance, energy recovered during the braking operations of the vehicle can be converted and stored. The batteries are generally very temperature-sensitive and should be operated, during loading and unloading, within a narrow temperature range. In particular, the heat which is generated and released during operation of the battery can be dissipated, since otherwise a heavy thermal loading of the battery cells ensues, which can lead to lasting damage. Therefore a cooling of the batteries is regularly necessary in order to avoid overheating thereof.

At high external temperatures, cooling is particularly important, since under high solar radiation, for example, the temperatures in the vehicle interior and the trunk rise strongly and the batteries are often disposed there, for example in the spare-wheel pan.

### SUMMARY

The object is therefore to define a simple, cost-effective and environmentally friendly option for cooling a battery in a vehicle.

This object is achieved by (a) a cooling apparatus for cooling a battery in a vehicle by means of a coolant, (b) a vehicle and (c) a method for cooling a battery in a vehicle by means of a coolant.

The cooling apparatus and method are based on the basic idea of using condensate of an air conditioning system which is present in the vehicle, for example for cooling the vehicle interior, for the battery cooling. This condensate, for example in the form of condensation water, is hitherto released unused into the environment.

This condensate is collected in a collecting vessel and utilized in a separate cooling circuit for cooling of the battery. Moreover, the possibility exists of providing a further cooling circuit, utilizing the heat exchanger of the air conditioning system, in order to cool the coolant for the cooling of the battery.

The otherwise unused condensate can hereby be put to good use, namely the cooling of the battery. A more far-reaching cooling of the battery by means of an air conditioning system or refrigeration system, and the lines which are necessary for this, can be avoided. Furthermore, the use of the condensate does not impair the efficiency of the air conditioning system and no substantial changes to the subassemblies are necessary, so that the implementation of the cooling apparatus can be realized in a cost-effective and simple manner.

The apparatus for cooling a battery in a vehicle by means of a coolant has a first heat exchanger (heat transfer device) for the transfer of heat between the coolant and the battery. The first heat exchanger serves for the heat transfer from the battery to the coolant, so that surplus heat can be dissipated at the battery, i.e. the battery is cooled. To this end, the first heat exchanger can be disposed beneath the battery, related to the installation situation in the vehicle, or can be configured such that the battery is at least partially enclosed by the first heat exchanger in order to enable a cooling which is as effective as possible.

In addition, the apparatus possesses a pumping device and a collecting vessel for the coolant, which are connected to each other by means of coolant lines, for example in the form of hoses, with the formation of a first coolant circuit.

The pumping device here serves for the conveyance of the coolant in the first coolant circuit, i.e. from the collecting vessel to the first heat exchanger and back again. The pumping device can possess a suction hose, with which the coolant is sucked up out of the collecting vessel and fed to the coolant line. Preferredly, the pumping device can be configured such that the coolant is sucked up close to the bottom of the collecting vessel, related to the installation situation in the vehicle, in order that, in the event of temperature fluctuations of the coolant in the collecting vessel, coldest possible coolant is fed to the first cooling circuit.

For instance, this can be a case of an electrically driven pumping device, which can be configured to control or regulate the flow rate of the coolant, so that the coolant can be circulated in the first coolant circuit according to requirement. For example, for this purpose, a pump as is normally used for the operation of the windshield washer system can be used.

The collecting vessel is connected via a condensate line to an air conditioning system of the vehicle, for example the air conditioning system for the air conditioning of the vehicle interior, so that condensate (condensation water) which forms during the operation of the air conditioning system can be led into the collecting vessel. The otherwise unused condensate of the air conditioning system can thus be used as coolant for the battery cooling.

According to various design variants, the first coolant circuit can be configured as an open circuit, for example in that the surface of the collecting vessel is connected to the atmospheric pressure. For instance, the collecting vessel can possess an overflow, which is configured to lead off surplus coolant from the collecting vessel, for instance if the coolant level in the collecting vessel exceeds a certain fill height. Surplus coolant can arise, for example, where condensate is introduced continuously into the collecting vessel. Thus the temperature of the coolant can be kept low, since the newly supplied condensate regularly has a lower temperature than the coolant already present in the collecting vessel. This can enable a particularly effective cooling of the battery.

The condensate inflow of the collecting vessel, i.e. the connection between collecting vessel and condensate line, can be disposed or arranged in the lower region of the collecting vessel, related to the installation situation in the vehicle. Too strong a mixing of the newly introduced cold condensate with the warmer coolant already present in the collecting vessel can thereby be avoided. This enables the preferred drainage of the warmer coolant by means of the overflow. Moreover, a return flow of the coolant from the first heat exchanger into the upper region of the collecting vessel can help to avoid mixing.

If no new condensate is introduced into the collecting vessel, for example because the air conditioning system of the vehicle is no longer in operation, the remaining coolant can circulate in the first coolant circuit. To this end, the first coolant circuit can be closed or closed off.

According to further design variants, the collecting vessel can be connected by means of coolant lines, with the formation of a second coolant circuit, to a second heat exchanger for the heat transfer between the coolant and a refrigerant. The refrigerant can be, for example, the refrigerant of the air conditioning system of the vehicle.

For instance, the second heat exchanger can be constituted by the heat exchanger of the air conditioning system of the vehicle, which heat exchanger in this case, besides the air conditioning of the vehicle interior, effects a cooling of the coolant, in that the coolant is led in a suitable manner, for example by means of aluminum pipes, along the heat exchanger of the air conditioning system.

This enables a cooling of the coolant, for instance should the cooling capacity achievable through the use of the condensate be insufficient.

The new and improved vehicle has a cooling apparatus according to the above description. For instance, this can be a case of an electric or hybrid electric vehicle, which, for the storage of electrical energy for the propulsion of the vehicle, has a traction battery which requires cooling. Correspondingly, the condensate of the air conditioning system can in this case be used to cool the traction battery in an electric or hybrid electric vehicle.

In particular, the vehicle can be configured or formed as a mild hybrid vehicle. This is a case of a vehicle in which an electric drive part supports the internal combustion engine in order to increase the power. The electromotive power can lie, for example, within a range between 6 and 14 kW/t. Moreover, the possibility can exist of using the electric motor for the recovery (recuperation) of braking energy, so that the recovered braking energy can be used to recharge the battery.

According to the method for cooling a battery in a vehicle by means of a coolant, a coolant is led, for example pumped, from a collecting vessel to a first heat exchanger. By means of the first heat exchanger, heat is transferred from the battery to the coolant. After this, the coolant heated by means of the first heat exchanger is led back into the collecting vessel, so that a first coolant circuit is formed.

It is provided that the condensate of an air conditioning system of the vehicle is led into the collecting vessel and, after this, serves as coolant for the cooling of the battery.

The method can be executed, for instance, by means of the apparatus explained in the above. In this regard, the above statements serve to explain the apparatus and also to describe the method.

According to various design variants, surplus coolant can be led off from the collecting vessel. For this, as described above, an overflow of the collecting vessel can be utilized, for example.

According to further design variants, the coolant can be led from the collecting vessel to a second heat exchanger. By means of the second heat exchanger, heat can be transferred from the coolant to a refrigerant and, after this, the coolant cooled by means of the second heat exchanger can be led back into the collecting vessel, so that a second coolant circuit is formed. For instance, the refrigerant can be constituted by the refrigerant of the air conditioning system of the vehicle.

### BRIEF DESCRIPTION OF THE DRAWING FIGURES

The cooling apparatus, vehicle and method shall be explained in greater detail below with reference to an illustrative embodiment. The associated drawing shows:

FIG. 1 is a schematic representation of the apparatus.

FIG. 2 is a schematic representation of an alternative embodiment of the apparatus.

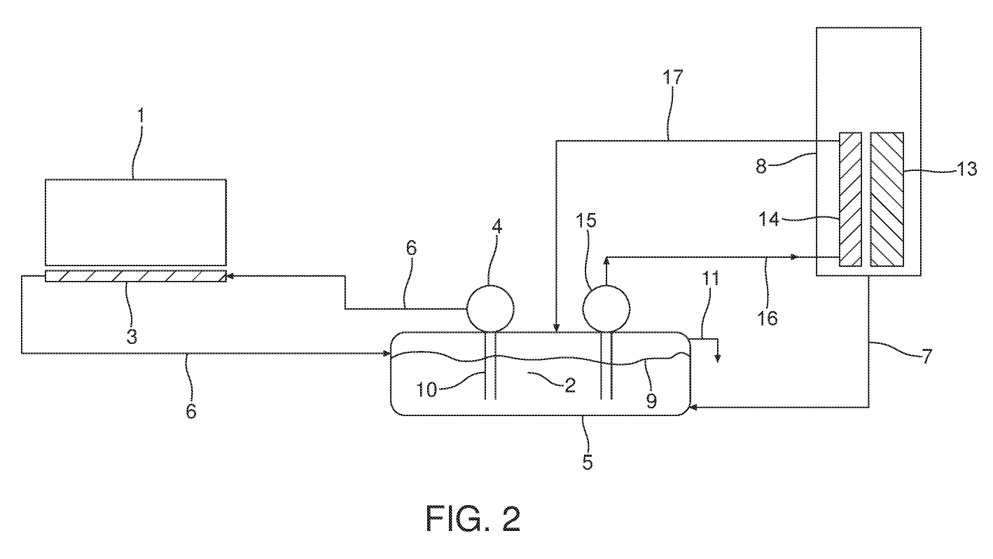

### DETAILED DESCRIPTION

In the example explained below, reference is made to the attached drawing, which forms a part of the example and in which, by way of illustration, a specific embodiment in which the cooling apparatus, vehicle and method can be worked is shown. Obviously, other embodiments can be used, and structural or logical changes made, without deviating from the scope of the description. The following description should therefore not be interpreted in a restrictive sense, and the scope of this document is defined by the appended claims.

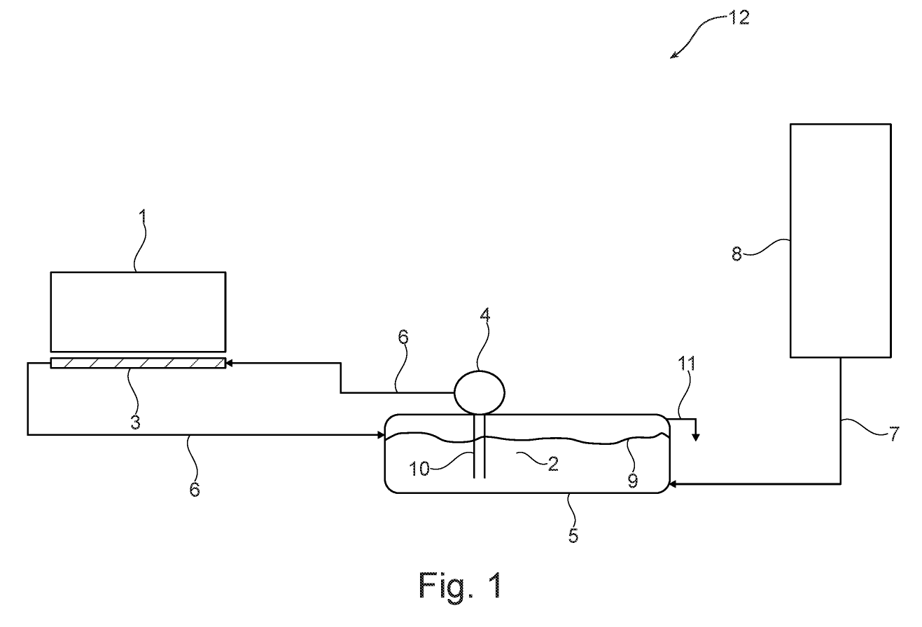

The illustrative embodiment according to FIG. 1 shows a cooling apparatus 12 for cooling a traction battery such as the battery 1 in a hybrid electric vehicle, in particular in a mild hybrid electric vehicle. The cooling apparatus 12 has a first heat exchanger 3, which is disposed beneath the battery 1, so that heat can be transferred from the battery 1 to a coolant flowing through the first heat exchanger 3. In addition a collecting vessel 5 is present, in which the coolant 2 is collected.

A pumping device 4 is arranged such that, by means of a suction hose 10 belonging to the pumping device 4, coolant is pumped out of the collecting vessel 5 and can be fed to a coolant line 6, which leads the coolant to the first heat exchanger 3. Further coolant lines 6 lead the coolant from the first heat exchanger 3 back again into the collecting vessel 5, so that a first coolant circuit is formed.

The collecting vessel 5 is connected moreover, by means of a condensate line 7, to the air conditioning system 8 of the vehicle, which serves for the air conditioning of the vehicle interior, so that a condensate arising at the air conditioning system 8 can be led into the collecting vessel 5. This condensate serves as the coolant 2 for cooling of the battery 1.

In the illustrative embodiment, the first coolant circuit is configured as an open circuit. The collecting vessel 5 possesses in the upper region an overflow 11. If the coolant level 9 in the collecting vessel 5 exceeds a certain fill height, then surplus coolant 2 is led off from the collecting vessel 5.

The condensate inflow is disposed in the lower region of the collecting vessel 5, so that the introduced cold condensate mixes as little as possible with the coolant 2 already found in the collecting vessel 5. The suction opening of the suction hose 10 is likewise located in the lower region of the collecting vessel 5, so that preferredly coldest possible coolant 2 is sucked up and led to the first heat exchanger 3. The return flow of the coolant 2 from the first heat exchanger 3 back into the collecting vessel 5 takes place preferredly in the upper region of the collecting vessel 5, likewise in order largely to avoid mixing with the coolant already found in the collecting vessel 5.

As long as condensate, i.e. cold water, is provided by the air conditioning system 8 and is introduced into the collecting vessel 5, surplus coolant 2, which generally has a higher temperature than the supplied condensate, can be led off from the collecting vessel 5. If no new condensate is any longer supplied, the remaining coolant 2 can circulate in the first coolant circuit.

Optionally, the collecting vessel 5 can be connected by means of further coolant lines 16, 17 to a second heat exchanger 14, with the formation of a second coolant circuit, in order that heat can be transferred from the coolant 2 to a refrigerant (not represented). The second pump 15 moves the coolant 2 through the coolant lines 16, 17 of the second coolant circuit. The refrigerant can be constituted by the refrigerant of the air conditioning system 8. Moreover, as the second heat exchanger, the heat exchanger of the air conditioning system 8 can be utilized (also note evaporator core 13).

What is claimed:

1. A cooling apparatus for cooling a battery in a vehicle with a coolant, comprising:
a first coolant circuit including a first heat exchanger, a pump device and a collecting vessel for said coolant connected by coolant lines; and
a condensate line connecting said collecting vessel to an air conditioning system of the vehicle whereby condensate is introduced into said collecting vessel.

2. The cooling apparatus as claimed in claim 1, wherein the first coolant circuit is an open circuit.

3. The cooling apparatus as claimed in claim 1, wherein the collecting vessel is connected by means of said coolant lines, with a second coolant circuit, to a second heat exchanger for heat transfer between the coolant and a refrigerant.

4. The cooling apparatus as claimed in claim 3, wherein the refrigerant is the refrigerant of the air conditioning system of the vehicle.

5. The cooling apparatus as claimed in claim 4, wherein the first heat exchanger is disposed beneath the battery or is arranged to at least partially enclose the battery.

6. The cooling apparatus of claim 1, wherein the first heat exchanger is disposed beneath the battery or is arranged to at least partially enclose the battery.

7. A vehicle having the cooling apparatus as claimed in claim 1.

8. The vehicle as claimed in claim 7, configured as an electric vehicle.

9. The vehicle as claimed in claim 7, configured as a hybrid electric vehicle.

10. The vehicle as claimed in claim 9, configured as a mild hybrid electric vehicle.

11. A method for cooling a battery in a vehicle by use of a coolant, comprising:
circulating, by a pump device, the coolant between a collecting vessel and a first heat exchanger;
transferring heat from the battery to the coolant in said first heat exchanger; and
adding, a condensate line, condensate from an air conditioning system to the coolant.

12. The method as claimed in claim 11, including directing surplus coolant to a second coolant circuit.

13. The method as claimed in claim 12, including:
circulating said coolant in said second coolant circuit to a second heat exchanger;
transferring heat from the coolant to a refrigerant in the second heat exchanger; and
returning the coolant back to the collecting vessel.

14. The method as claimed in claim 13 including returning said refrigerant from said second heat exchanger to said air conditioning system of the vehicle.
